(19) United States
(12) Patent Application Publication
(10) Pub. No.: US 2025/0367925 A1
(43) Pub. Date: Dec. 4, 2025

(54) PRINTING APPARATUS

(71) Applicant: CANON KABUSHIKI KAISHA, Tokyo (JP)

(72) Inventor: AKIYOSHI SAHARA, Chiba (JP)

(21) Appl. No.: 19/220,257

(22) Filed: May 28, 2025

(30) Foreign Application Priority Data
May 31, 2024 (JP) 2024-089071

(51) Int. Cl. B41J 2/045

(52) U.S. Cl. CPC B41J 2/04573; B41J 2/04586

(57) ABSTRACT

A printing apparatus includes a reading unit configured to read an image of a document; a printing unit including a conveyance unit configured to convey a print medium and a print head configured to eject ink onto the print medium to print an image; and a control unit configured to control a document reading operation, in which the reading unit reads the image of the document, and a printing operation, in which the conveyance unit conveys the print medium and the print head prints the image. In a case where a predetermined operation in the printing operation is started after waiting for the document reading operation to stop, the control unit changes an ink discharge amount in a recovery operation for recovering an ejection state of ink ejected from the print head.

### BACKGROUND OF THE INVENTION

### Cross Reference to Priority Application

This application claims the benefit of Japanese Patent Application No. 2024-089071, filed May 31, 2024, which is hereby incorporated by reference herein in its entirety.

### FIELD OF THE INVENTION

The present disclosure relates to a printing apparatus.

### DESCRIPTION OF THE RELATED ART

An inkjet printing apparatus is known in which preliminary ejection of ink is performed by a print head during or at the completion of a conveyance operation for conveying a print medium, such as a print medium feeding operation or a print medium front/back reversing operation. By performing preliminary ejection to recover the performance of the print head, ejection failure in the print head can be suppressed even if a time period occurs during which ink is not ejected from the print head due to a conveyance operation. Japanese Patent Laid-Open No. 2016-43495 discloses a technology for omitting preliminary ejection at the completion of a feeding operation in a case where the time period during which ink is not ejected from the print head is short in the feeding operation.

Further, it is known that reducing the power supply capacity of a printing apparatus to the minimum necessary size contributes to downsizing the printing apparatus and reducing the manufacturing costs. Japanese Patent Laid-Open No. 2023-158430 discloses a technology that makes it possible to suppress the power consumption of a printing apparatus and reduce the power supply capacity by shifting the execution timings of multiple parallel operations in the printing apparatus.

In a printing apparatus equipped with a reading unit that reads an image of a document, it is possible to suppress the power consumption of the printing apparatus by shifting the execution timings of a document reading operation performed by the reading unit and an operation of conveying a print medium. In this case, the operation of conveying the print medium starts after the document reading operation is stopped, and thus the time period during which ink is not ejected from the print head increases. If the amount of ink ejected from the print head during preliminary ejection is set taking this into consideration, the amount of ink ejected during preliminary ejection will increase.

### SUMMARY OF THE INVENTION

A printing apparatus according to an embodiment of the present disclosure includes: a reading unit configured to read an image of a document; a printing unit including a conveyance unit configured to convey a print medium and a print head configured to eject ink onto the print medium conveyed by the conveyance unit to print an image; and a control unit configured to control a document reading operation, in which the reading unit reads the image of the document, and a printing operation, in which the conveyance unit conveys the print medium and the print head prints the image, wherein, in a case where a predetermined operation in the printing operation is started after waiting for the document reading operation to stop, the control unit changes an ink discharge amount in a recovery operation for recovering an ejection state of ink ejected from the print head from the ink discharge amount in the recovery operation performed in a case where the waiting time for the document reading operation to stop is less than a predetermined time period.

Further features of the present invention will become apparent from the following description of exemplary embodiments with reference to the attached drawings.

### BRIEF DESCRIPTION OF THE DRAWINGS

FIG. 1 is a perspective view of a printing apparatus;

FIG. 2 is a perspective view illustrating a printing unit of the printing apparatus;

FIG. 3 is a side cross-sectional view of the printing unit;

FIG. 4A and FIG. 4B are side cross-sectional views illustrating a conveyance path of a print medium;

FIG. 5A and FIG. 5B are side cross-sectional views illustrating the conveyance path of a print medium;

FIG. 6A and FIG. 6B are plan views illustrating a flatbed scanner unit;

FIG. 7A and FIG. 7B are side cross-sectional views illustrating the conveyance path of a document in an ADF scanner unit;

FIG. 8A and FIG. 8B are side cross-sectional views illustrating the conveyance path of a document in the ADF scanner unit;

FIG. 9 is a perspective view of a recovery unit;

FIG. 10 is a schematic diagram illustrating the positional relationship between a print head and a cap;

FIG. 11 is a block diagram illustrating a control system of the printing apparatus;

FIG. 12 is a schematic diagram illustrating the relationship between torque of a DC motor and current flowing through the DC motor;

FIG. 13A and FIG. 13B are schematic diagrams illustrating the relationship between power consumption of each motor and the power supply capacity;

FIG. 14 is a flowchart illustrating an example of control for a document reading operation by the ADF scanner unit;

FIG. 15 is a flowchart illustrating an example of control for a double-sided printing operation by the printing unit; and

FIG. 16 is a flowchart illustrating an example of control for a front/back reversing operation by the printing unit.

### DESCRIPTION OF THE EMBODIMENTS

Hereafter, a detailed explanation is given of preferable embodiments of the present disclosure with reference to the accompanying drawings. Note that the following embodiments are not intended to limit the contents of the present disclosure, and every combination of the characteristics explained in the following embodiments is not necessarily essential to the solutions provided in the present disclosure. It should be understood that, within the range not deviating from the gist of the present disclosure, modifications and improvements appropriately made to the following embodiments based on the ordinary knowledge of a person skilled in the art also fall within the scope of the present disclosure. Note that the same configurations are explained with the same signs.

### First Embodiment

### <Configuration of the Printing Apparatus>

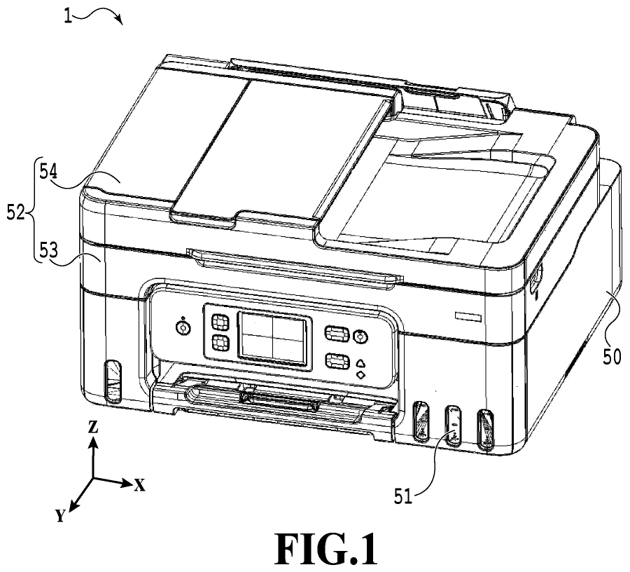

FIG. 1 is a perspective view of the inkjet printing apparatus 1 (hereinafter referred to as the printing apparatus 1) according to the present embodiment. The printing apparatus 1 according to the present embodiment is a multifunction peripheral that has a function of printing an image on a print medium, a function of reading an image of a document, and a function of copying the image of the document on a print medium. As illustrated in FIG. 1, the printing apparatus 1 includes the casing 50, the printing unit 51, and the reading unit 52. The printing unit 51 is installed inside the casing 50. The reading unit 52 is installed on the upper part of the casing 50. Note that, in each drawing referenced below, the Z direction indicates the vertical direction, which intersects (perpendicularly in the present embodiment) the X-Y plane that is defined by the X direction and the Y direction.

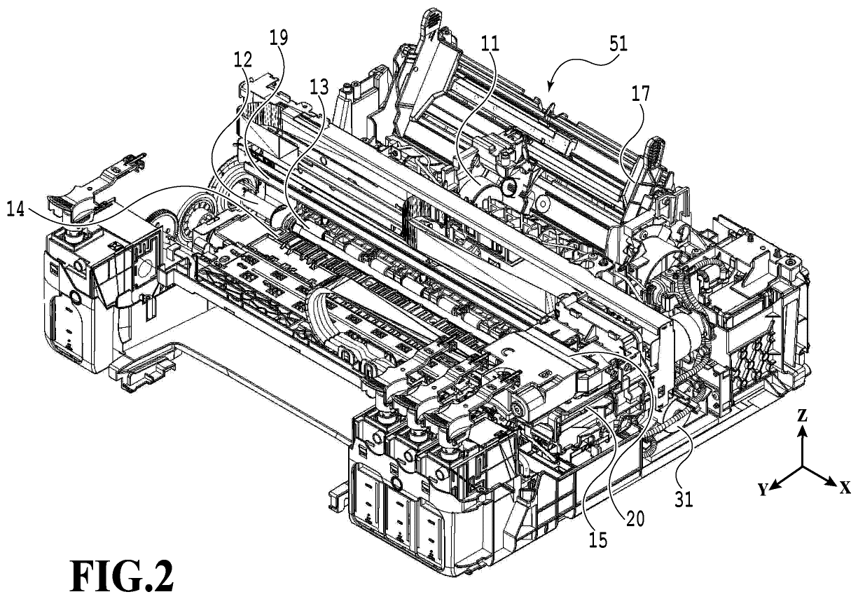

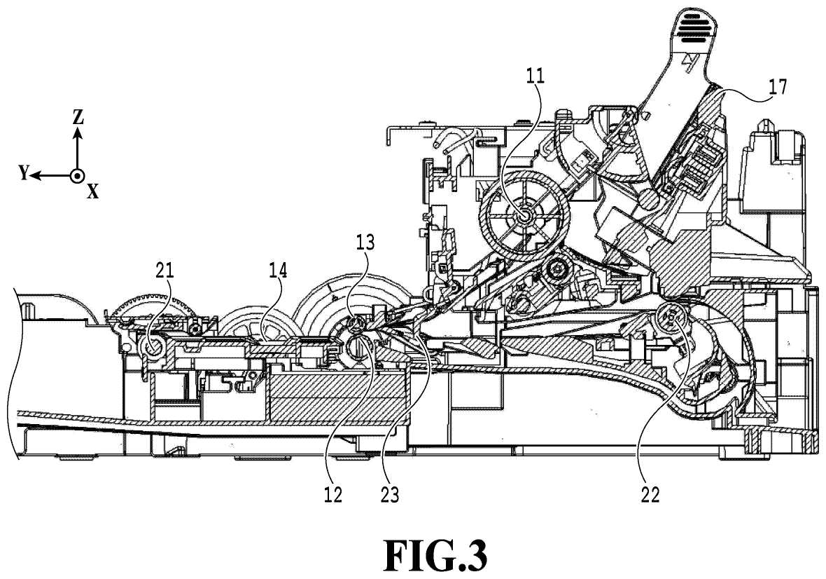

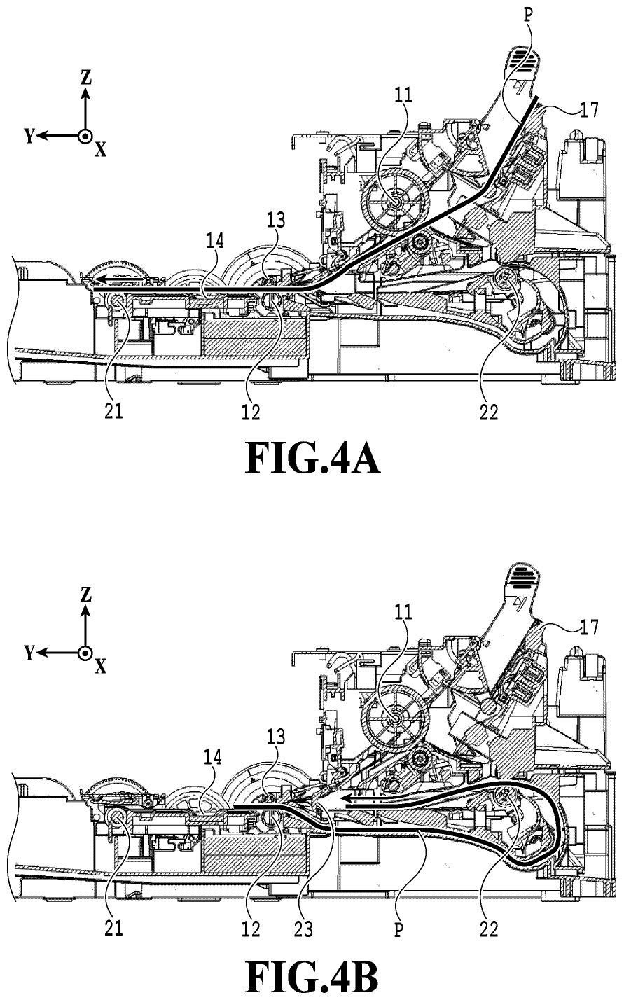

FIG. 2 is a perspective view illustrating the printing unit 51 of the printing apparatus 1. FIG. 3 is a side cross-sectional view of the printing unit 51. As illustrated in FIG. 2 and FIG. 3, the printing unit 51 is equipped with a conveyance unit including the feed roller 11, the conveyance roller 12, the pinch roller 13, the discharge roller 21, and the relay roller 22. Furthermore, the printing unit 51 includes the platen 14, the print head 15, the carriage 20, and the print feeding unit 17. The feed roller 11 rotates about an axis parallel to the X axis (clockwise as viewed from the front side of the paper plane of FIG. 3), so as to feed the print medium P, which is loaded on the print feeding unit 17, to the conveyance roller 12 (See FIG. 4A). Examples of the print medium P include sheet materials such as printing paper, plastic sheets, and OHP sheets. The conveyance roller 12 rotates about an axis parallel to the X axis to convey the print medium P fed from the feed roller 11. The pinch roller 13 pinches the print medium P between itself and the conveyance roller 12. The pinch roller 13 is associated with the conveyance roller 12 via the print medium P.

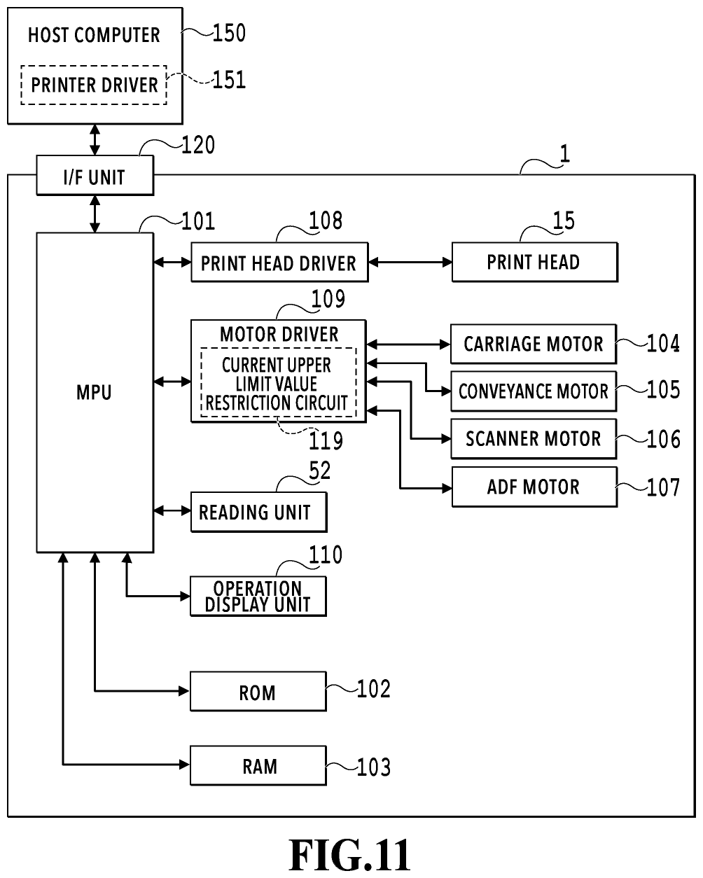

The print medium P is conveyed onto the platen 14 in the state nipped between the conveyance roller 12 and the pinch roller 13. Ink droplets ejected from ejection ports (not illustrated in the drawings) of the print head 15 land on the print medium P placed on the platen 14 to print characters, symbols, images, and the like. The print medium P on which an image or the like is printed is discharged by the discharge roller 21 to the outside of the casing 50 (for example, to a print discharge unit not illustrated in the drawings capable of loading the print medium P). Note that the feed roller 11, the conveyance roller 12, and the discharge roller 21 are driven by the conveyance motor 105 (See FIG. 11) to rotate. As illustrated in FIG. 2, the print head 15 is held by the carriage 20 so that the ejection ports face the print medium P. The carriage 20 is supported on the guide rail 19 in a free-to-slide manner with respect to the X direction. The carriage 20 supported by the guide rail 19 is driven by the carriage motor 104 (See FIG. 11). The print head 15 held by the carriage 20 reciprocally moves along the guide rail 19 in the X direction. Therefore, the print head 15 is capable of printing on any desired location in the width direction (the X direction) of the print medium P.

As illustrated in FIG. 3, the sheet detection sensor 23 is installed between the feed roller 11 and the conveyance roller 12. The sheet detection sensor 23 detects the print medium P fed to the conveyance roller 12 by the feed roller 11. If the sheet detection sensor 23 does not detect the print medium P even if the feed roller 11 rotates, then a jam error or the like has occurred.

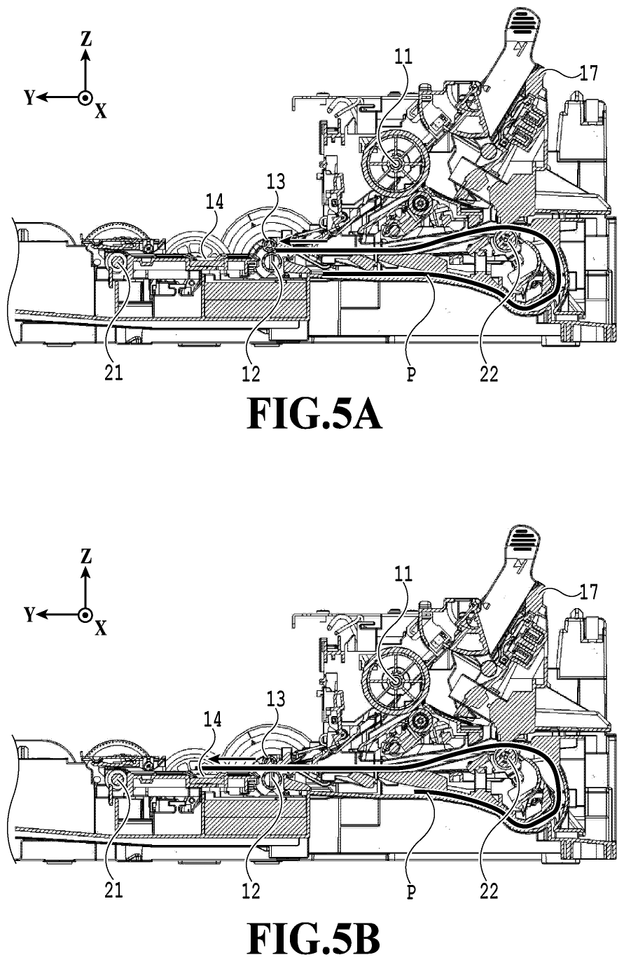

FIG. 4A and FIG. 4B and FIG. 5A and FIG. 5B are side cross-sectional views illustrating the conveyance path of the print medium P. FIG. 4A is a side cross-sectional view illustrating the conveyance path of the print medium P as a printing operation is performed on the first surface (the front side) of the print medium P. FIG. 4B is a side cross-sectional view illustrating the reversing path of the print medium P as the front/back reversing operation of the print medium P is performed. FIG. 5A is a side cross-sectional view illustrating an operation of correcting the tilt of the print medium P in the reversing path. FIG. 5B is a side cross-sectional view illustrating the conveyance path of the print medium P as a printing operation is performed on the second surface (the back side) of the print medium P.

In the conveyance path of the print medium P illustrated in FIG. 4A, a printing operation is performed on the first surface (the front side) of the print medium P. As described above, the print medium P loaded on the print feeding unit 17 is conveyed onto the platen 14 by the feed roller 11 and the conveyance roller 12. An image or the like is printed on the first surface of the print medium P placed on the platen 14 by the print head 15. The discharge roller 21 rotates about an axis parallel to the X axis (counterclockwise as viewed from the front side of the paper plane of FIG. 4A), so as to convey the print medium P in the discharge direction (the +Y direction). Once the printing operation on the first surface of the print medium P is completed, the discharge roller 21 rotates in the opposite direction (clockwise as viewed from the front side of the paper plane of FIG. 4A), so as to convey the print medium P in the direction opposite to the discharge direction (the −Y direction). The print medium P, which is conveyed in the direction opposite to the discharge direction of the print medium P, is again nipped between the conveyance roller 12 and the pinch roller 13.

Next, a front/back reversing operation of the print medium P is performed in the reversing path for the print medium P illustrated in FIG. 4B. The conveyance roller 12 rotates in the opposite direction (clockwise as viewed from the front side of the paper plane of FIG. 4B) of the direction during the printing operation on the first surface of the print medium P, so as to convey the print medium P to the relay roller 22 installed in the hairpin-shaped reversing path. The relay roller 22 rotates about an axis parallel to the X axis (counterclockwise as viewed from the front side of the paper plane of FIG. 4B), so as to convey the print medium P to the conveyance roller 12. At this time, the front and back of the print medium P are reversed and turned upside down. Note that the relay roller 22 has a drive source (the conveyance motor 105 illustrated in FIG. 11) common with the conveyance roller 12, but rotates in the same direction regardless of the rotation direction of the conveyance roller 12. Further, as illustrated in FIG. 4B, once the leading edge of the print medium P moves to a position immediately before reaching the sheet detection sensor 23, the conveyance roller 12 (the conveyance motor 105) stops temporarily.

Next, as illustrated in FIG. 5A, in the reversing path of the print medium P, a tilt correction operation for correcting the tilt of the print medium P is performed. The conveyance roller 12 temporarily stops during the front/back reversing operation of the print medium P, and then rotates again in the opposite direction (clockwise as viewed from the front side of the paper plane of FIG. 5A). The leading edge of the print medium P conveyed by the relay roller 22 passes through the sheet detection sensor 23 and abuts on the conveyance roller 12 rotating in the opposite direction. The leading edge of the print medium P abuts on the conveyance roller 12 rotating in the opposite direction, thereby correcting the tilt of the print medium P.

Next, in the conveyance path of the print medium P illustrated in FIG. 5B, a printing operation is performed on the second surface (the back side) of the print medium P. After the correction operation for the print medium P, the conveyance roller 12 rotates in the same direction (counterclockwise as viewed from the front side of the paper plane of FIG. 5B) as in the printing operation on the first surface (the front side) of the print medium P. The print medium P, with its front and back reversed and turned upside down, is conveyed onto the platen 14 by the conveyance roller 12. An image or the like is printed by the print head 15 on the second surface of the print medium P placed on the platen 14. The discharge roller 21 rotates in the same direction (counterclockwise as viewed from the front side of the paper plane of FIG. 5B) as in the printing operation on the first surface of the print medium P, so as to convey the print medium P in the discharge direction (the +Y direction). Once the printing operation on the second surface of the print medium P is completed, the print medium P is discharged to the outside of the casing 50 (to the print discharge unit) by the discharge roller 21. The series of operations illustrated in FIG. 4A, FIG. 4B, FIG. 5A, and FIG. 5B make it possible to perform printing on both surfaces of the print medium P with a single feeding operation from the feed roller 11. Hereinafter, the printing operation on both sides of the print medium P by the printing unit 51 is referred to as a double-sided printing operation. The conveyance operation for performing printing on both surfaces of the print medium P is referred to as a double-sided conveyance operation for the print medium P.

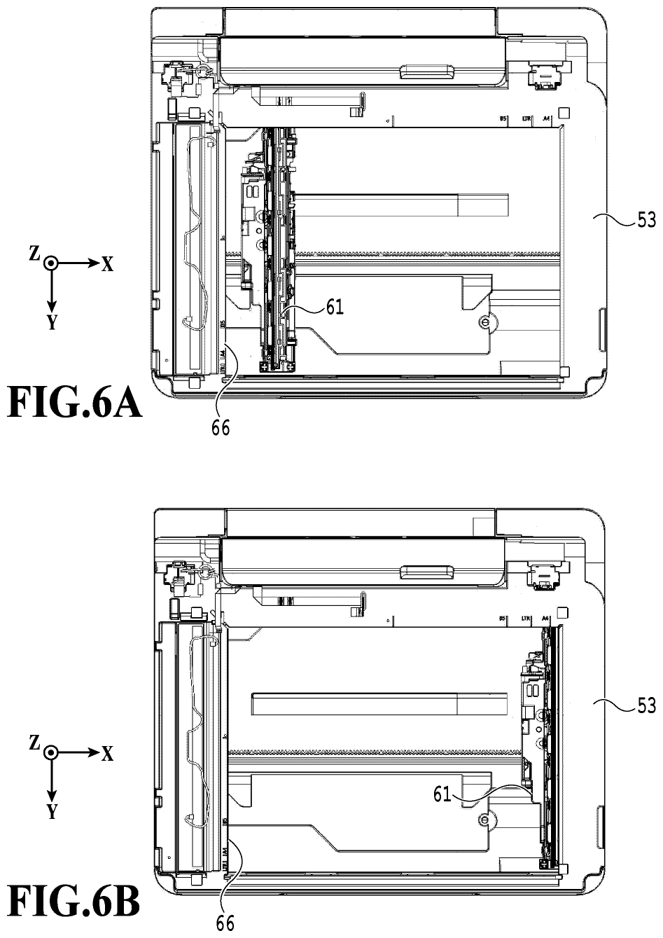

As illustrated in FIG. 1, the reading unit 52 is equipped with the flatbed scanner unit 53 and the ADF scanner unit 54 as two types of document reading units. FIG. 6A and FIG. 6B are plan views illustrating the flatbed scanner unit 53. FIG. 6A is a plan view illustrating a state in which the reading sensor 61 is moving in the flatbed scanner unit 53. FIG. 6B is a plan view illustrating a state in which the reading sensor 61 in the flatbed scanner unit 53 has moved to the second reading position.

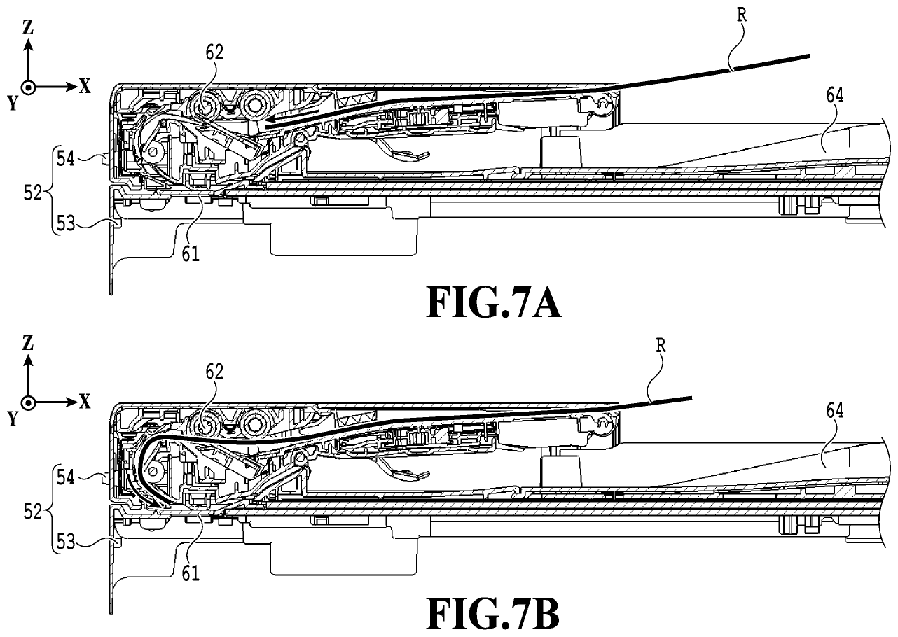

As illustrated in FIG. 6A, the flatbed scanner unit 53 includes the reading sensor 61 for reading an image of a document, and the document table 66. The reading sensor 61 is formed to extend in the width direction (the Y direction) of the document. The reading sensor 61 is capable of moving in the X direction between the first reading position (See FIG. 7A) at the end side in the −X direction and the second reading position (See FIG. 6B) at the end side in the +X direction below the document table 66. The reading sensor 61 is driven by the scanner motor 106 (See FIG. 11). The flatbed scanner unit 53 reads an image of a document placed on the document table 66 by moving the reading sensor 61 in the X direction using the scanner motor 106 to scan the document.

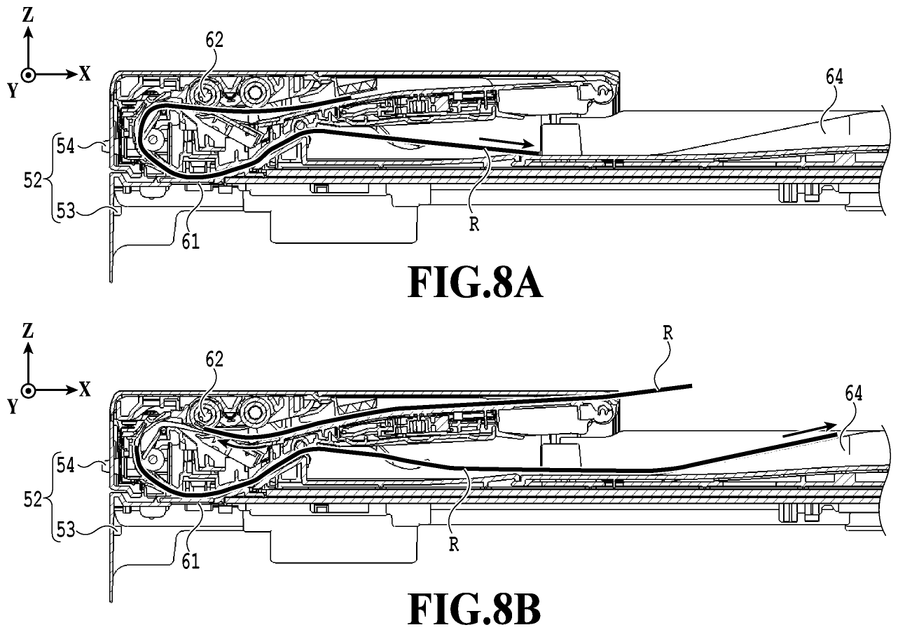

FIG. 7A and FIG. 7B and FIG. 8A and FIG. 8B are side cross-sectional views illustrating the conveyance path of documents in the ADF scanner unit 54. FIG. 7A is a side cross-sectional view illustrating the conveyance path of the document R fed from a reading feed unit (not illustrated in the drawings). FIG. 7B is a side cross-sectional view illustrating the conveyance path of the document R fed from the reading feed unit to a position immediately before the reading sensor 61. FIG. 8A is a side cross-sectional view illustrating the conveyance path of the document R passing above the reading sensor 61. FIG. 8B is a cross-sectional view illustrating the conveyance path of the document R conveyed to the reading discharge unit 64.

As illustrated in FIG. 7A, the ADF scanner unit 54 includes the reading sensor 61 described above. Furthermore, the ADF scanner unit 54 includes the reading feed roller 62, the reading feed unit (not illustrated in the drawings), and the reading discharge unit 64 as an automatic document feeder (ADF). The reading feed roller 62 conveys the document R loaded on the reading feed unit to the reading discharge unit 64 via above the reading sensor 61 that has moved to the first reading position. The reading feed roller 62 is driven by the ADF motor 107 (See FIG. 11) to rotate.

As illustrated in the order illustrated in FIG. 7A and FIG. 7B, the document R is fed by the reading feed roller 62 from the reading feed unit to the conveyance path in the ADF scanner unit 54 and conveyed above the reading sensor 61. Thereafter, as illustrated in the order illustrated in FIG. 8A and FIG. 8B, the document R is made to pass above the reading sensor 61 and conveyed to the reading discharge unit 64 by the reading feed roller 62. As the document R passes above the reading sensor 61, the image of the document R is read by the reading sensor 61. In a case where a plurality of the documents R is loaded in the reading feed unit, as illustrated in FIG. 8B, the subsequent document R is fed to the conveyance path in the ADF scanner unit 54 before the preceding document R passing above the reading sensor 61 is discharged to the reading discharge unit 64.

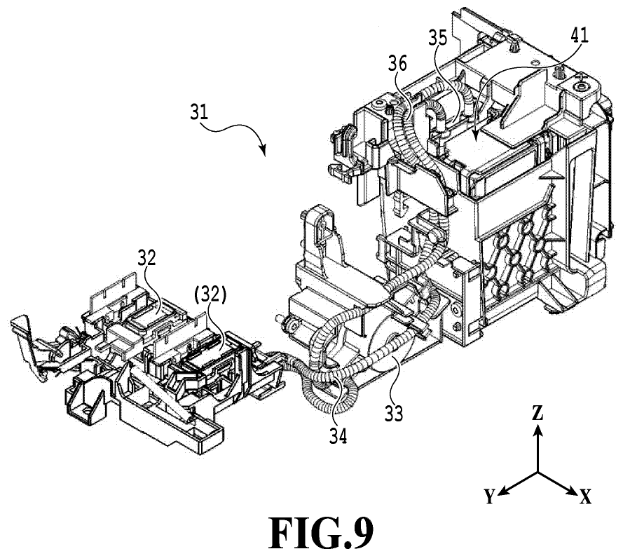

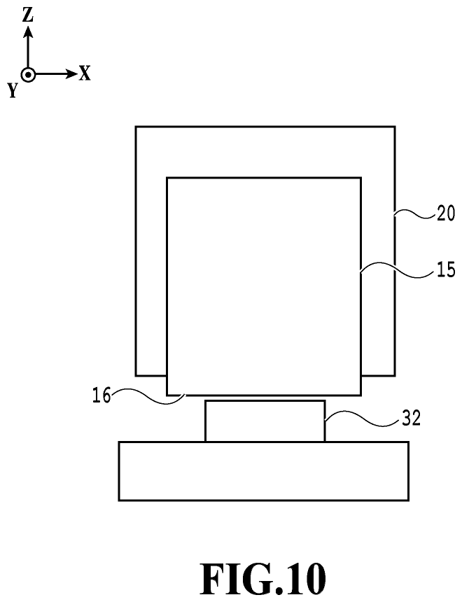

Further, as illustrated in FIG. 2, the printing apparatus 1 is equipped with the recovery unit 31. FIG. 9 is a perspective view of the recovery unit 31. As illustrated in FIG. 9, the recovery unit 31 is equipped with the cap 32, the suction pump 33, the suction tube 34, the discharge tube 36, the discharge unit 35, and the waste ink tank 41. The cap 32 caps the ejection surface 16 (See FIG. 10) formed at the lower part of the print head 15. Multiple ejection ports (not illustrated in the drawings) for ejecting ink from the print head 15 are formed on the ejection surface 16 of the print head 15. Note that the cap 32 includes two caps, one for black ink and one for color ink, but a detailed description of each cap 32 is omitted. The suction pump 33 suctions the ink from within the cap 32 via the suction tube 34. The suction tube 34 connects the cap 32 and the suction pump 33. The discharge unit 35 discharges the waste ink suctioned by the suction pump 33 into the waste ink tank 41. The discharge tube 36 connects the suction pump 33 and the discharge unit 35. The waste ink tank 41 stores the waste ink discharged from the discharge unit 35.

FIG. 10 is a schematic diagram illustrating the positional relationship between the print head 15 and the cap 32. In the inkjet printing apparatus, if the print head 15 does not eject ink for a predetermined time period or longer, there is a possibility that the ink within the print head 15 may dry out and result in ejection failure. In order to suppress the occurrence of ejection failure, it is necessary to perform preliminary ejection using the print head 15. During preliminary ejection, as illustrated in FIG. 10, the carriage 20 moves in the X direction to a position where the ejection surface 16 of the print head 15 faces the cap 32. Then, the print head 15 ejects ink toward the cap 32 without printing an image. By performing preliminary ejection using the print head 15 above the cap 32, it is possible for the recovery unit 31 to collect the waste ink into the waste ink tank 41.

### <Control System of the Printing Apparatus>

FIG. 11 is a block diagram illustrating the control system of the printing apparatus 1 according to the present embodiment. As illustrated in FIG. 11, the printing apparatus 1 is equipped with, as a control unit, the MPU 101, the ROM 102, the RAM 103, the print head driver 108, and the motor driver 109. Furthermore, the printing apparatus 1 is equipped with the operation display unit 110 and the I/F unit 120. The MPU (Micro Processing Unit) 101 performs control of the entire printing apparatus 1, including the operation of each unit, data processing, etc. The MPU 101 is electrically connected to the ROM 102, the RAM 103, the print head driver 108, and the motor driver 109. The ROM (Read Only Memory) 102 stores the programs to be executed by the MPU 101 and various kinds of data. The RAM (Random Access Memory) 103 temporarily stores the processing data to be executed by the MPU 101, the data received from the host computer 150, etc.

The print head driver 108 controls the print head 15. The motor driver 109 controls the carriage motor 104, the conveyance motor 105, the scanner motor 106, and the ADF motor 107. The motor driver 109 includes the current upper limit value restriction circuit 119 that sets the upper limit value of the current to be applied to the carriage motor 104, the conveyance motor 105, the scanner motor 106, and the ADF motor 107. The current upper limit value restriction circuit 119 is capable of setting upper limit values in multiple steps for the current. The upper limit values for the current, which are set in multiple steps by the current upper limit value restriction circuit 119, are switchable based on a command from the MPU 101.

Further, the MPU 101 is electrically connected to the operation display unit 110, the reading unit 52, and the I/F unit 120. The operation display unit 110 transmits an operation signal corresponding to an operation on the operation display unit 110 to the MPU 101. The reading unit 52 transmits the image data of the document read by the reading sensor 61 to the MPU 101. The MPU 101 performs communication with the host computer 150 via the I/F unit (interface unit) 120. For example, the MPU 101 is capable of outputting the image data of the document transmitted from the reading unit 52 to the host computer 150 via the I/F unit 120. The host computer 150 is equipped with the printer driver 151 for compiling printing information related to the printed images, the quality of the printed images, etc., and transmitting them to the printing apparatus 1 in a case where the user commands the execution of a printing operation.

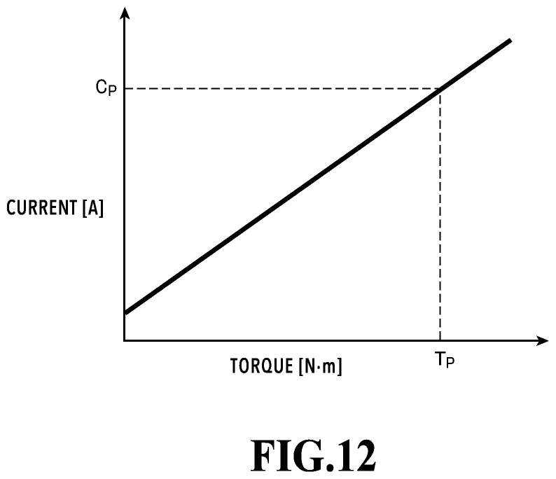

Next, an explanation is given about the relationship between the upper limit value of the current flowing through the motor and the power supply capacity. FIG. 12 is a schematic diagram illustrating the relationship between the torque [N·m] of a DC motor and the current [A] flowing through the DC motor. In order to meet the demands for cost reduction and high stopping accuracy, a DC motor is used for each of the carriage motor 104, the conveyance motor 105, the scanner motor 106, and the ADF motor 107. As illustrated in FIG. 12, there is a substantially linear relationship between the torque of a DC motor and the current flowing through the DC motor. That is, as a large torque is generated in a DC motor, the value of the current flowing through the DC motor also reaches a high value. If the upper limit value Cp of the current which is set by the current upper limit value restriction circuit 119 is high, the torque Tp corresponding to the upper limit value Cp of the current also becomes large. The power consumption of a motor is proportional to the square of the current flowing through the motor, and thus if a large current flows through the motor, the motor consumes a large amount of power.

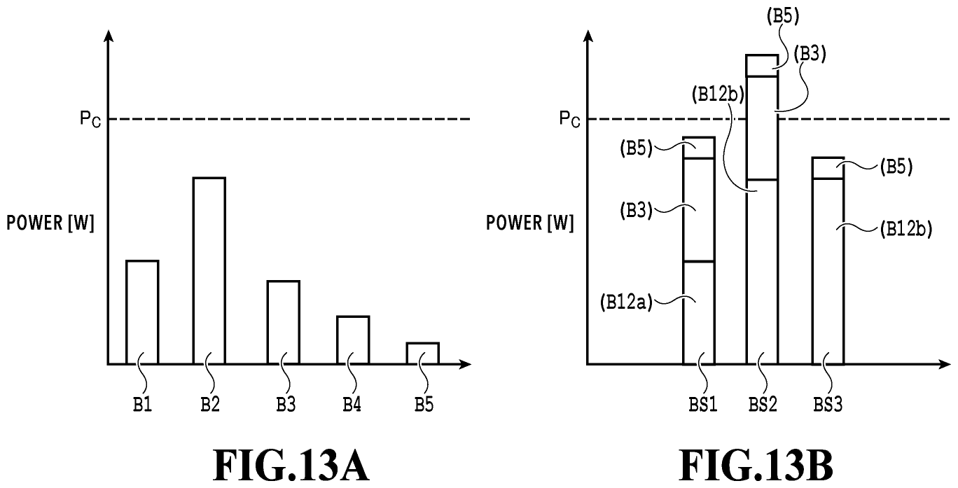

FIG. 13A and FIG. 13B are schematic diagrams illustrating the relationship between the power consumption and the power supply capacity of each motor. FIG. 13A is a schematic diagram illustrating the relationship between the power consumption [W] of each the conveyance motor 105, the carriage motor 104, the ADF motor 107, the scanner motor 106, and the other power consuming units, and the power supply capacity Pc of the printing apparatus 1. The first bar graph B1 in FIG. 13A indicates the maximum power consumption of the conveyance motor 105. The second bar graph B2 in FIG. 13A indicates the maximum power consumption of the carriage motor 104. The third bar graph B3 in FIG. 13A indicates the maximum power consumption of the ADF motor 107. The fourth bar graph B4 in FIG. 13A indicates the maximum power consumption of the scanner motor 106. The fifth bar B5 in FIG. 13A indicates the maximum power consumption of the other power consuming units (not illustrated in the drawings). The power consumption of each of the conveyance motor 105, the carriage motor 104, the ADF motor 107, the scanner motor 106, and the other power consuming units is smaller than the power supply capacity Pc.

FIG. 13B is a graph illustrating the relationship between the totals of the power consumption in a case where multiple motors are operating simultaneously and the power supply capacity Pc. As illustrated in the first total bar graph BS1, in many cases where the printing unit 51 and the reading unit 52 perform operations in parallel, the total of the power consumption of each motor in the printing unit 51 (B12a), the power consumption of the ADF motor 107, and the power consumption of the other power consuming units is equal to or less than the power supply capacity Pc. As illustrated in the second total bar graph BS2, in a case where the power consumption of each motor in the printing unit 51 is high, the total of the power consumption of each motor in the printing unit 51 (B12b), the power consumption of the ADF motor 107, and the power consumption of the other power consuming units is greater than the power supply capacity Pc. If the total power consumption temporarily exceeds the power supply capacity Pc, there is a possibility that a momentary interruption will occur due to a power shortage. Such a case in which the power consumption (B12b) of each motor in the printing unit 51 is high as illustrated by the second total bar graph BS2 may be, for example, a case in which the operation for correcting the tilt of the print medium P is performed. In a case where the operation for correcting the tilt of the print medium P is not being performed, the power consumption (B12a) of each motor in the printing unit 51 is relatively low, as illustrated by the first total bar graph BS1. As illustrated in the third total bar graph BS3, by performing exclusive control to restrict the operation of one of the printing unit 51 and the reading unit 52 (for example, the reading unit 52), sufficient power can be allocated to the operation of the printing unit 51, which consumes a large amount of power. For example, as illustrated by the third total bar graph BS3, the total of the power consumption of each motor in the printing unit 51 (B12b) and the power consumption of the other power consuming units is smaller than the power supply capacity Pc. Note that, in many cases, it is unlikely that exclusive control will degrade operability since the printing unit 51 and the reading unit 52 can operate in parallel.

### <Control Method for the Printing Apparatus>

Next, a description is given about the control method for the printing apparatus 1 according to the present embodiment. In the printing apparatus 1, a document reading operation for reading an image of the document R is performed by the reading unit 52 (the flatbed scanner unit 53 or the ADF scanner unit 54). The printing unit 51 performs a printing operation for printing an image on the print medium P based on the printing information (the image data) transmitted from the host computer 150. Furthermore, in the printing apparatus 1, a copying operation in which the image of the document R read by the reading unit 52 is printed on the print medium P is performed by the printing unit 51. The document reading operation, the printing operation, and the copying operation are controlled by the MPU 101 which constitutes a control unit. Except for the case of performing a predetermined operation during the printing operation (for example, an operation for correcting the tilt of the print medium P), the printing unit 51 and the reading unit 52 can operate in parallel.

As described above, during the double-sided printing operation in which the printing unit 51 prints images on both the front and back sides of the print medium P, the double-sided conveyance operation of the print medium P is performed by a series of operations illustrated in FIG. 4A, FIG. 4B, FIG. 5A, and FIG. 5B. During the tilt correction operation in which the leading edge of the print medium P is made to abut on the conveyance roller 12, the print medium P is strongly pressed against the reversing path, requiring a large torque from the conveyance motor 105 that drives the relay roller 22 to rotate, and thus the power consumption of the conveyance motor 105 increases. If the torque of the conveyance motor 105 is insufficient during the operation for correcting the tilt of the print medium P, the tilt correction for the print medium P will be inadequate, resulting in printing being performed while the print medium P remains tilted. During the operation for correcting the tilt of the print medium P, by performing exclusive control to restrict the operation of one of the printing unit 51 and the reading unit 52 (for example, the reading unit 52), it is possible to allocate sufficient power to the operation of the conveyance motor 105, which consumes a large amount of power. After the operation for correcting the tilt of the print medium P is performed, the parallel operation of the printing unit 51 and the reading unit 52 is resumed.

### <Document Reading Operation>

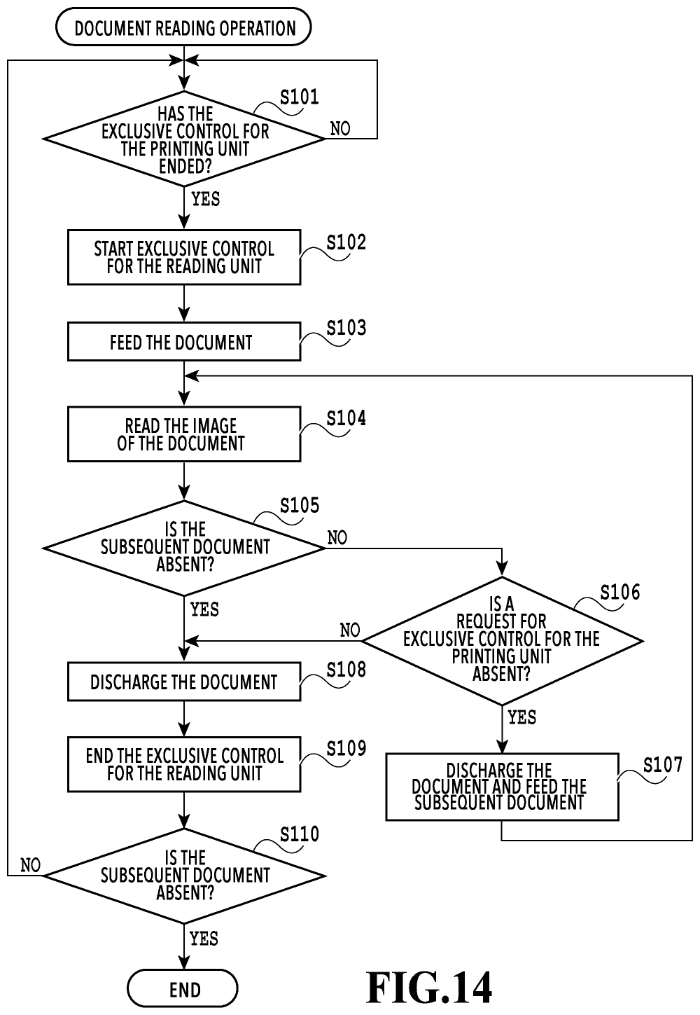

FIG. 14 is a flow chart illustrating an example of the control for the document reading operation performed by the ADF scanner unit 54. In the following description, each step is simply denoted as S101, etc. Further, the MPU 101 executes a control program stored in the ROM 102, thereby executing each step (process) of the flowchart illustrated in FIG. 14.

In S101, the MPU 101 determines whether or not the exclusive control for the printing unit 51 has ended. Here, the exclusive control for the printing unit 51 refers to control that restricts operations of the reading unit 52, including the ADF scanner unit 54, in a case where the printing unit 51 temporarily performs an operation that consumes a large amount of power, as explained using FIG. 13B. Note that, while the exclusive control for the printing unit 51 is being performed, a flag may be set to indicate that the exclusive control for the printing unit 51 is being performed. While the exclusive control for the printing unit 51 is being performed, that is, in a case where the determination in S101 is NO, the MPU 101 cannot proceed the processing from S101. During this time, the MPU 101 causes the printing unit 51 to perform an operation that consumes a large amount of power (for example, the operation for correcting the tilt of the print medium P). In a case where the exclusive control for the printing unit 51 has ended, that is, if the determination in S101 is YES, the MPU 101 proceeds the processing to S102.

In S102, the MPU 101 starts the exclusive control for the reading unit 52. Here, the exclusive control for the reading unit 52 is opposite to the exclusive control for the printing unit 51 described above, and refers to control that restricts operations of the printing unit 51 that consume a large amount of power while the reading unit 52, including the ADF scanner unit 54, is operating. Note that, while the exclusive control for the reading unit 52 is being performed, a flag may be set to indicate that the exclusive control for the reading unit 52 is being performed.

In S103, the MPU 101 feeds one of the documents R loaded on the reading feed unit (not illustrated in the drawings) to the conveyance path in the ADF scanner unit 54 by the reading feed roller 62 (the ADF motor 107), so that the document R is conveyed above the reading sensor 61.

In S104, the MPU 101 causes the document R fed from the reading feed unit to pass above the reading sensor 61 using the reading feed roller 62 (the ADF motor 107), so that an image of the document R is read by the reading sensor 61. At this time, the MPU 101 may use the ADF scanner unit 54, including the reading sensor 61, to read images on both the front and back sides of the document R or to read an image on only one side of the document R.

In S105, the MPU 101 determines whether or not the subsequent document R loaded on the reading feed unit is absent. For example, by using a document detection sensor (not illustrated in the drawings) mounted in the reading feed unit to detect the presence or absence of the document R in the reading feed unit, it is possible to determine whether or not the subsequent document R is loaded on the reading feed unit. In a case where no subsequent document R is loaded on the reading feed unit, the images of all of the documents R loaded on the reading feed unit have been read. In a case where the subsequent document R is loaded on the reading feed unit, that is, in a case where the determination in S105 is NO, the MPU 101 proceeds the processing to S106. In a case where the subsequent document R is not loaded on the reading feed unit, that is, in a case where the determination in S105 is YES, the MPU 101 proceeds the processing to S108.

In S106, the MPU 101 determines whether or not a request for exclusive control for the printing unit 51 is absent. Note that a state in which a request for exclusive control for the printing unit 51 is present refers to a state in which the printing unit 51 is attempting to temporarily perform an operation that consumes a large amount of power, but the operation of the printing unit 51 is restricted by the exclusive control for the reading unit 52. In a case where a request for exclusive control for the printing unit 51 is present, that is, in a case where the determination in S106 is NO, the MPU 101 proceeds the processing to S108. In a case where a request for exclusive control for the printing unit 51 is absent, that is, in a case where the determination in S106 is YES, the MPU 101 proceeds the processing to S107.

In S107, the MPU 101 discharges the document R read in S104 to the reading discharge unit 64 using the reading feed roller 62 (the ADF motor 107). Further, at this time, the MPU 101 feeds one of the documents R loaded on the reading feed unit to the conveyance path in the ADF scanner unit 54 using the reading feed roller 62 (the ADF motor 107), so that the document R is conveyed above the reading sensor 61. By simultaneously discharging the read document R and feeding the subsequent document R, the time period required to read the images of multiple documents R can be shortened. After S107, the MPU 101 returns to S104 to read the image of the subsequent document R. In a case where multiple documents R are loaded on the reading feed unit and a request for exclusive control for the printing unit 51 is absent, the MPU 101 repeats S104 and S107 to read the images of the multiple documents R continuously.

In S108, the MPU 101 discharges the document R read in S104 to the reading discharge unit 64 using the reading feed roller 62 (the ADF motor 107). Note that, unlike in S107, the subsequent document R is not fed.

In S109, the MPU 101 ends the exclusive control for the reading unit 52. In a case where the operation of the printing unit 51 is restricted by the exclusive control for the reading unit 52, the MPU 101 starts the double-sided printing operation to be performed by the printing unit 51 and performs exclusive control for the printing unit 51 (details are described later).

In S110, the MPU 101 determines whether or not the subsequent document R loaded on the reading feed unit is absent, similarly to S105. In a case where the subsequent document R is loaded on the reading feed unit, that is, in a case where the determination in S110 is NO, the MPU 101 returns to S101. Note that, during the exclusive control for the printing unit 51, the MPU 101 restricts the operation of the reading unit 52 in S101. As described above, in a case where the subsequent document R is not loaded on the reading feed unit, the images of all of the documents R loaded on the reading feed unit have been read. In a case where the subsequent document R is not loaded on the reading feed unit, that is, in a case where the determination in S110 is YES, the MPU 101 ends the processing. Note that, since the flatbed scanner unit 53 is configured to read the image of one document, a description of the control of the document reading operation performed by the flatbed scanner unit 53 is omitted.

### <Double-Sided Printing Operation>

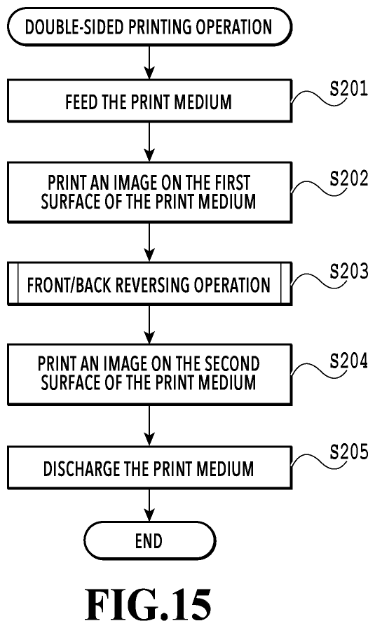

FIG. 15 is a flowchart illustrating an example of the control for the double-sided printing operation performed by the printing unit 51. Note that each step (process) in the flowchart illustrated in FIG. 15 is executed by the MPU 101 executing the control program stored in the ROM 102. Further, the example of the control for the double-sided printing operation illustrated in FIG. 15 is an example of the control in which images are printed on both the front and back sides of one sheet of the print medium P.

In S201, the MPU 101 feeds the print medium P to the conveyance roller 12 using the feed roller 11 (the conveyance motor 105), and conveys the print medium P onto the platen 14 using the conveyance roller 12 (the conveyance motor 105). As the print medium P is fed, the MPU 101 abuts the leading edge of the print medium P onto the conveyance roller 12 to correct the tilt of the print medium P. At this time, the torque required by the conveyance motor 105, i.e., the power consumption of the conveyance motor 105, is smaller than that required for the front/back reversing operation described later. This allows the printing unit 51 and the reading unit 52 to operate in parallel, and therefore, the MPU 101 does not perform the exclusive control for the printing unit 51 (or the exclusive control for the reading unit 52).

In S202, the MPU 101 prints an image on the first surface (the front side) of the print medium P on the conveyance path of the print medium P illustrated in FIG. 4A. At this time, the MPU 101 conveys the print medium P onto the platen 14 using the conveyance roller 12, moves the carriage 20 in the X direction of FIG. 4A using the carriage motor 104, and ejects ink from the print head 15 toward the first surface of the print medium P.

In S203, the MPU 101 performs the front/back reversing operation of the print medium P using the printing unit 51. The details of the front/back reversing operation are described later.

In S204, the MPU 101 prints an image on the second surface (the back side) of the print medium P on the conveyance path of the print medium P illustrated in FIG. 5B. At this time, the MPU 101 conveys the print medium P onto the platen 14 using the conveyance roller 12, moves the carriage 20 in the X direction of FIG. 5B using the carriage motor 104, and ejects ink from the print head 15 toward the second surface of the print medium P.

In S205, the MPU 101 discharges the print medium P, on which images are printed on both the front and back surfaces, to the outside of the casing 50 (to the printing discharge unit) using the discharge roller 21 (the conveyance motor 105), and ends the processing. Note that, in the flowchart illustrated in FIG. 15, by omitting the processes of S203 and S204, it is possible to perform a single-sided printing operation in which the printing unit 51 prints an image on one side of the print medium P.

### <Front/Back Reversing Operation>

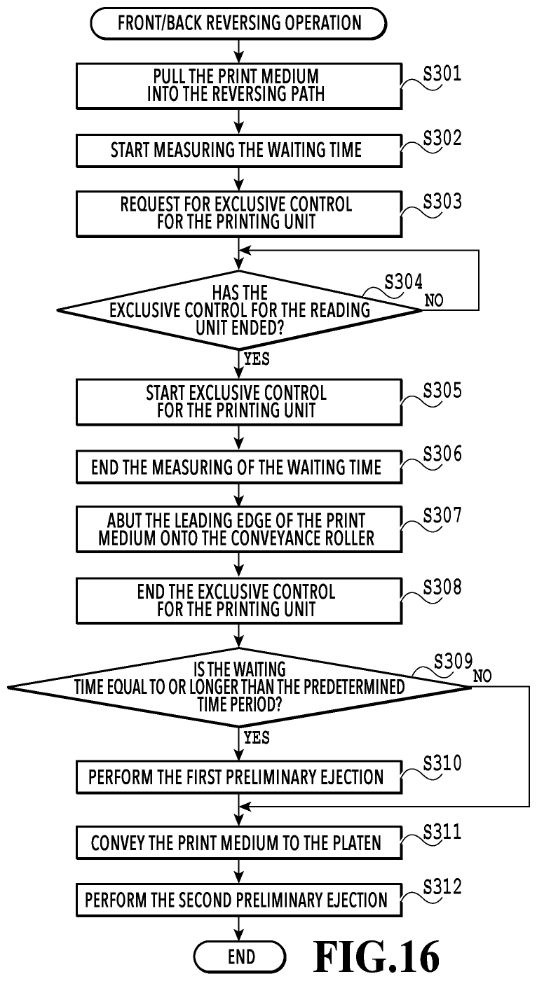

FIG. 16 is a flowchart illustrating an example of the control for the front/back reversing operation by the printing unit 51. Note that each step (process) in the flowchart illustrated in FIG. 16 is executed by the MPU 101 executing the control program stored in the ROM 102.

In S301, the MPU 101 causes the conveyance roller 12 to rotate in the direction opposite to the direction of rotation during the printing operation on the print medium P using the conveyance motor 105, thereby pulling the print medium P into the reversing path illustrated in FIG. 4B. At this time, once the leading edge of the print medium P moves to a position immediately before reaching the sheet detection sensor 23, the MPU 101 stops the rotation of the conveyance roller 12 (the conveyance motor 105).

In S302, the MPU 101 starts measuring the waiting time. Here, the waiting time refers to the time period during which the processing cannot proceed due to repetition of S304, which is described later.

In S303, the MPU 101 requests for the exclusive control for the printing unit 51. In order to perform an operation that temporarily consumes a large amount of power (an operation of correcting the tilt of the print medium P) in S307, which is described later, the MPU 101 attempts to prevent the operation of the reading unit 52.

In S304, the MPU 101 determines whether or not the exclusive control for the reading unit 52 has ended. While the exclusive control for the reading unit 52 is being performed, that is, in a case where the determination in S304 is NO, the MPU 101 does not proceed the processing from S304. Note that, by requesting for the exclusive control for the printing unit 51, the MPU 101 ends the exclusive control for the reading unit 52 as shown in the example of the control for the document reading operation. In a case where the exclusive control for the reading unit 52 has ended, that is, in a case where the determination in S304 is YES, the MPU 101 proceeds the processing to S305.

In S305, the MPU 101 starts the exclusive control for the printing unit 51. By carrying out S303 to S305, the operation of the reading unit 52 is restricted, and sufficient power can be allocated to the operation of the printing unit 51 (the conveyance motor 105) in which a large amount of power is consumed.

In S306, the MPU 101 ends the measurement of the waiting time that is started in S302. In the present embodiment, the MPU 101 measures the time difference between the time at which the processing of S302 is performed and the time at which the processing of S306 is performed as the waiting time, and stores the waiting time in the RAM 103.

In S307, the MPU 101 conveys the print medium P using the relay roller 22 (the conveyance motor 105) and performs the tilt correction operation for correcting the tilt of the print medium P by abutting the leading edge of the print medium P onto the conveyance roller 12 rotating in the opposite direction. At this time, as described above, a large torque is required for the conveyance motor 105, but the exclusive control for the printing unit 51 makes it possible to allocate sufficient power to the operation of the conveyance motor 105.

In S308, the MPU 101 ends the exclusive control for the printing unit 51. In a case where the operation of the reading unit 52 is restricted by the exclusive control for the printing unit 51, the MPU 101 resumes the operation of the reading unit 52 as shown in the example of the control for the document reading operation.

In S309, the MPU 101 obtains the waiting time measured in S302 and S306 from the RAM 103, and determines whether or not the waiting time is equal to or longer than a predetermined time period. In a case where the waiting time is less than the predetermined time period, that is, in a case where the determination in S309 is NO, the MPU 101 proceeds the processing to S311. In a case where the waiting time is equal to or longer than the predetermined time period, that is, in a case where the determination in S309 is YES, the MPU 101 proceeds the processing to S310.

In S310, the MPU 101 causes the print head 15 to perform the first preliminary ejection. In the first preliminary ejection, the print head 15 ejects the first ink amount from the ejection ports multiple times. If the waiting time increases due to the repetition of S304, the time period during which ink is not ejected from the print head 15 increases. Therefore, the MPU 101 performs both the first preliminary ejection and the second preliminary ejection, so as to eject a larger amount of ink than in cases where the waiting time is shorter (than the predetermined time period), thereby suppressing ejection failure of the print head 15. On the other hand, in a case where the waiting time is shorter than the predetermined time period, the MPU 101 omits the first preliminary ejection, thereby suppressing an increase in the amount of ink used for preliminary ejection and appropriately reducing the amount of waste ink discarded without being used in the printing operation. In this way, by changing the amount of ink ejected from the print head 15 for preliminary ejection in accordance with the waiting time, it is possible to perform the preliminary ejection with an appropriate amount of ink.

In S311, the MPU 101 conveys the print medium P, with its front and back reversed and turned upside down, onto the platen 14 using the conveyance roller 12 (the conveyance motor 105). At this time, the MPU 101 rotates the conveyance roller 12 in the same direction as in the printing operation on the first surface (the front side) of the print medium P.

In S312, the MPU 101 causes the print head 15 to perform the second preliminary ejection, and then ends the processing. In the second preliminary ejection, the print head 15 ejects the second ink amount from the ejection ports multiple times. Even in a case where the first preliminary ejection of S310 is omitted, the MPU 101 performs the second preliminary ejection, thereby suppressing ejection failure of the print head 15 even though a time period during which ink is not ejected from the print head 15 occurs due to the print medium P being pulled into the reversing path.

Here, the relationship between the amount of ink ejected from the print head 15 during preliminary ejection and the waiting time is described. The longer the time period during which ink is not ejected from the print head 15, the greater the amount of ink required in the preliminary ejection to resolve the ejection failure. In the present embodiment, the first ink amount may be set according to the maximum time period (for example, 10 seconds) required for the MPU 101 to execute the control of FIG. 16 (the control of the front/back reversing operation) in a case where the waiting time is less than the predetermined time period (for example, 3 seconds). Further, the second ink amount may be set according to the time period required for the MPU 101 to execute the control of FIG. 16 and to the first ink amount in a case where the waiting time is at its maximum. The maximum waiting time in the present embodiment is the time period required for the MPU 101 to execute S102 to S105, S108, and S109 of FIG. 14, i.e., the time period required for the reading operation for one sheet of the document R, and is, for example, 60 seconds.

In the present embodiment, in a case where the waiting time is equal to or longer than the predetermined time period, ejection failure of the print head 15 is suppressed by performing a combination of the first preliminary ejection and the second preliminary ejection. However, the method of preliminary ejection is not limited to this. For example, the MPU 101 may continuously change the amount of ink ejected from the print head 15 during preliminary ejection in accordance with the measured waiting time.

### <Copying Operation>

Next, an explanation is given about the copying operation for printing an image of the document R on the print medium P with reference to FIG. 14 to FIG. 16. In the present embodiment, an explanation is given about a case where images of the multiple documents R are printed on both the front and back sides of the print medium P. Once the user of the printing apparatus 1 loads the multiple documents R on the reading feed unit (not illustrated in the drawings) of the ADF scanner unit 54 and performs an operation to start the copying operation on the operation display unit 110, the MPU 101 starts the copying operation. At this time, the user of the printing apparatus 1 loads a sufficient number of sheets of the print medium P for printing images of the multiple documents R on the print feeding unit 17 of the printing unit 51.

In the copying operation, first, the document reading operation by the ADF scanner unit 54 illustrated in FIG. 14 is started. At the start of the copying operation, the exclusive control for the printing unit 51 is not being performed, so the MPU 101 immediately proceeds the processing from S101 to S102 and the subsequent processes. Once the MPU 101 reads an image of one sheet of the document R in the processing up to S104, the MPU 101 starts the double-sided printing operation performed by the printing unit 51 illustrated in FIG. 15. Note that, while the subsequent document R is loaded on the reading feed unit and there is no request for the exclusive control for the printing unit 51, the MPU 101 repeats S104 and S107 to read the images of the multiple documents R continuously.

Upon starting the double-sided printing operation by the printing unit 51, the MPU 101 performs the printing operation on the first surface (the front side) of the print medium P by executing the processing of S201 and S202. After the MPU 101 performs the printing operation on the first surface of the print medium P, the MPU 101 performs the front/back reversing operation illustrated in FIG. 16 as the processing of S203. During the front/back reversing operation, the MPU 101 pulls the print medium P into the reversing path in S301, and then requests for the exclusive control for the printing unit 51 in S303. In the document reading operation illustrated in FIG. 14, the MPU 101 suspends continuous reading of the image of the document R based on the determination made in S106 and ends the exclusive control for the reading unit 52 in S109. In the front/back reversing operation illustrated in FIG. 16, once the MPU 101 ends the exclusive control for the reading unit 52, the processing proceeds from S304 to S305, where the MPU 101 starts the exclusive control for the printing unit 51, including the tilt correction operation. At this time, in the document reading operation illustrated in FIG. 14, the MPU 101 waits for the exclusive control for the printing unit 51 to end in S101. Therefore, in the front/back reversing operation illustrated in FIG. 16, the MPU 101 can execute the processing of S307 (the operation for correcting the tilt of the print medium P) which consumes a large amount of power while restricting the operation of the reading unit 52. Once the MPU 101 ends the exclusive control for the printing unit 51 in S308, the processing proceeds to S102 and the subsequent processes in the document reading operation illustrated in FIG. 14, so that the document reading operation is resumed. On the other hand, in the front/back reversing operation illustrated in FIG. 16, the MPU 101 proceeds the processing up to S312 to perform preliminary ejection of an appropriate amount of ink (the first preliminary ejection and the second preliminary ejection), thereby suppressing ejection failure of the print head 15. Once the front/back reversing operation illustrated in FIG. 16 ends, the MPU 101 performs the printing operation on the second surface (the back side) of the print medium P in the processing from S204 onward in the double-sided printing operation illustrated in FIG. 15.

The double-sided printing operation illustrated in FIG. 15 is executed once for each sheet of the print medium P (the front and back sides) in accordance with the progress of the document reading operation illustrated in FIG. 14. Once the reading of the images of all of the documents R loaded on the reading feed unit of the ADF scanner unit 54 is completed, the MPU 101 ends the document reading operation illustrated in FIG. 14. After that, in the front/back reversing operation illustrated in FIG. 16, since the waiting time in S304 is eliminated, the MPU 101 can appropriately reduce the amount of waste ink by omitting the first preliminary ejection in S310 to keep the ink discharge amount unchanged. As described above, the MPU 101 executes the processing of S307 (the operation for correcting the tilt of the print medium P), which consumes a large amount of power, while restricting the operation of the reading unit 52. As the MPU 101 starts the exclusive control for the printing unit 51 after ending the exclusive control for the reading unit 52, the MPU 101 recovers the ejection state of ink to be ejected from the print head 15 by performing the preliminary ejection of an appropriate amount of ink. Therefore, even if the power supply capacity of the printing apparatus 1 is reduced, the performance of the print head 15 can be recovered, and ejection failure of the print head 15 can be suppressed. Upon printing the images of all of the documents R on the print medium P, the MPU 101 ends the copying operation.

As described above, according to the present embodiment, it is possible to suppress an increase in the amount of ink ejected in the preliminary ejection. In the present embodiment, in a case where the MPU 101 waits a predetermined time period or longer for the document reading operation to stop and then starts a predetermined operation in the printing operation (for example, the tilt correction operation), the MPU 101 changes the amount of ink to be discharged in the recovery operation to recover the ejection state of ink to be ejected by the print head 15. As the recovery operation, for example, the preliminary ejection of ink is performed by the print head 15 to recover ejection state of the ink. The MPU 101 increases the amount of ink ejected from the print head 15 at the time of preliminary ejection (for example, to an amount that is the total of the first ink amount and the second ink amount) as the waiting time for the document reading operation to stop (the waiting time described above) increases. As a result, even if the time period during which ink is not ejected from the print head 15 increases due to waiting for the document reading operation to stop, the performance of the print head 15 can be recovered by performing the preliminary ejection of an appropriate amount of ink after starting the tilt correction operation (the predetermined operation). On the other hand, in a case where the time period (the waiting time) for the document reading operation to stop is less than the predetermined time period, the MPU 101 does not change the amount of ink to be discharged in the recovery operation. In this way, it is possible to suppress an increase in the amount of ink to be ejected in the preliminary ejection.

Further, the predetermined operation may be, for example, the tilt correction operation for correcting the tilt of the print medium P that has been reversed during the (double-sided) printing operation. The MPU 101 controls the printing unit 51 to reverse the print medium P on the reversing path, stop the double-sided printing operation midway, and then start the tilt correction operation after waiting for the document reading operation to stop. The MPU 101 performs the exclusive control to restrict the document reading operation during the tilt correction operation (the predetermined operation). This allows the tilt correction operation (the processing in S307) of the print medium P, which consumes a large amount of power during the double-sided printing operation, to be performed while restricting the operation of the reading unit 52, thereby allowing the power supply capacity of the printing apparatus 1 to be reduced.

### MODIFICATION EXAMPLES

In the above-described embodiment, the MPU 101 increases the amount of ink ejected from the print head 15 during the preliminary ejection as the above-described waiting time (in other words, the time period during which the double-sided printing operation is stopped midway) increases, but there is no such limitation. For example, the MPU 101 may increase the amount of ink ejected from the print head 15 during the preliminary ejection as the time period required for the operation performed by the printing unit 51 (the entire front/back reversing operation), including the waiting time for the document reading operation to stop, increases. In this case, the time period during which ink is not ejected from the print head 15 can be more accurately reflected in the amount of ink ejected from the print head 15 during the preliminary ejection. Further, not limited to changing the amount of ink (the number of times ink is ejected), the MPU 101 may also, for example, change the cycle at which the print head 15 ejects ink during preliminary ejection. While waiting for the document reading operation to stop, the MPU 101 may change the amount of ink ejected from the print head 15 during the preliminary ejection without measuring the waiting time described above.

In the above-described embodiment, the preliminary ejection of ink performed by the print head 15 is exemplified as a recovery operation for recovering the ejection state of ink to be ejected from the print head 15, but there is no such limitation. For example, the ink may be suctioned from the print head 15 by the suction pump 33 in the state where the ejection surface 16 of the print head 15 is capped with the cap 32 of the recovery unit 31.

In the above-described embodiment, the MPU 101 performs the exclusive control for the ADF scanner unit 54 during the document reading operation, and performs the exclusive control for the printing unit 51 during the operation for correcting the tilt of the print medium P in the front/back reversing operation, but there is no such limitation. For example, the MPU 101 may perform the exclusive control for the flatbed scanner unit 53 while the flatbed scanner unit 53 is performing the document reading operation. The MPU 101 may perform the exclusive control for the printing unit 51 during operations other than the tilt correction operation in the front/back reversing operation. Further, not limited to copying operations, in a case where the document reading operation and the double-sided printing operation are performed separately and in parallel, the exclusive control for the ADF scanner unit 54 may be performed during the document reading operation, and the exclusive control for the printing unit 51 may be performed during the operation for correcting the tilt of the print medium P in the front/back reversing operation.

In the above-described embodiment, the MPU 101 performs the exclusive control to restrict the document reading operation by the reading unit 52 during an operation (the tilt correction operation in the front/back reversing operation) that consumes a large amount of power in the double-sided printing operation, but there is no such limitation. For example, the MPU 101 may perform the exclusive control to restrict double-sided printing by the printing unit 51 during an operation that consumes a large amount of power in the document reading operation. Not limited to operations that consume a large amount of power, the MPU 101 may perform the exclusive control to restrict the document reading operation by the reading unit 52 during an operation that generates a lot of vibration, operational noise, and the like, in the double-sided printing operation. The MPU 101 may perform the exclusive control to restrict the double-sided printing operation by the printing unit 51 during an operation that generates a lot of vibration, operational noise, and the like, in the document reading operation.

In the above embodiment, the print head 15 is what is termed as a serial type print head that ejects ink while moving in the scanning direction, but there is no such limitation. The print head may be what is termed as a full-line type print head capable of ejecting ink across the whole area in the width direction of the print medium P without movement in the scanning direction.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A printing apparatus comprising:
a reading unit configured to read an image of a document;
a printing unit including a conveyance unit configured to convey a print medium and a print head configured to eject ink onto the print medium conveyed by the conveyance unit to print an image; and
a control unit configured to control a document reading operation, in which the reading unit reads the image of the document, and a printing operation, in which the conveyance unit conveys the print medium and the print head prints the image,
wherein, in a case where a predetermined operation in the printing operation is started after waiting for the document reading operation to stop, the control unit changes an ink discharge amount in a recovery operation for recovering an ejection state of ink ejected from the print head from the ink discharge amount in the recovery operation performed in a case where the waiting time for the document reading operation to stop is less than a predetermined time period.

2. The printing apparatus according to claim 1, wherein the control unit changes the ink discharge amount in the recovery operation in a case where the predetermined operation is started after waiting the predetermined time period or longer for the document reading operation to stop, and does not change the ink discharge amount in the recovery operation in a case where the waiting time for the document reading operation to stop is less than the predetermined time period.

3. The printing apparatus according to claim 1, wherein the ejection state is recovered by performing preliminary ejection of ink by the print head.

4. The printing apparatus according to claim 3, wherein the control unit increases an amount of ink ejected from the print head during the preliminary ejection in a case of changing the ink discharge amount in the recovery operation.

5. The printing apparatus according to claim 4, wherein the control unit increases the amount of ink ejected from the print head during the preliminary ejection with an increase in the waiting time for the document reading operation to stop.

6. The printing apparatus according to claim 4, wherein the control unit increases the amount of ink ejected from the print head during the preliminary ejection with an increase in a time period, including the waiting time for the document reading operation to stop, required for the printing unit to perform an operation.

7. The printing apparatus according to claim 1, wherein the control unit performs exclusive control to restrict the document reading operation during the predetermined operation.

8. The printing apparatus according to claim 1, wherein the print head ejects ink onto the print medium conveyed by the conveyance unit to print the image of the document read by the reading unit.

9. The printing apparatus according to claim 1, wherein the conveyance unit is capable of reversing the front and back sides of the print medium, and
wherein the predetermined operation includes a tilt correction operation for correcting a tilt of the print medium reversed front and back by the conveyance unit.

10. The printing apparatus according to claim 9, wherein the control unit changes the ink discharge amount in the recovery operation in a case where the tilt correction operation is started after waiting for the document reading operation to stop in a state where the printing operation is stopped midway with the print medium reversed front and back by the conveyance unit.
